(19) United States
(12) Patent Application Publication
(10) Pub. No.: US 2012/0187736 A1
(43) Pub. Date: Jul. 26, 2012

(54) VEHICLE SEAT

(75) Inventor: Matthias STROEHER, Ruesselsheim (DE)

(73) Assignee: GM GLOBAL TECHNOLOGY OPERATIONS LLC, Detroit, MI (US)

(21) Appl. No.: 13/357,218

(22) Filed: Jan. 24, 2012

(30) Foreign Application Priority Data
Jan. 25, 2011 (DE) 10 2011 009 341.9

(51) Int. Cl. B60N 2/02; B60N 2/44

(52) U.S. Cl. 297/353; 297/452.1; 297/452.41

(57) ABSTRACT

A vehicle seat, particularly for a motor vehicle, is provided that includes, but is not limited to a seat part and a backrest. The backrest includes, but is not limited to an elastic upholstery and a support for the upholstery. The support is a plate, and particularly a plastic plate.

### CROSS-REFERENCE TO RELATED APPLICATION

This application claims priority to German Patent Application No. 102011009341.9, filed Jan. 25, 2011, which is incorporated herein by reference in its entirety.

### TECHNICAL FIELD

The technical field relates to a vehicle seat and a motor vehicle.

### BACKGROUND

Vehicle seats are employed in motor vehicles to receive persons in the vehicle interior. In this regard, both front seats for a driver and a co-driver as well as backseats behind the front seats for further occupants of the motor vehicle are employed in motor vehicles. The vehicle seat comprises a seat part and a backrest as well as a head restraint fastened to the backrest. Here, the backrest has elastic upholstery, e.g., of foam rubber, and a cover of fabric is arranged on the upholstery. On this cover, as support surface a person can take a seat on the vehicle seat. Here, a support on the backrest is required for the upholstery.

The support in this case is produced from a wire mat or a wire mesh and because of this has elastic properties. This wire mat or the wire mesh in this case is generally fastened to a U-shaped frame. Because of the elastic properties of the wire mat, which in particular is also fastened to the frame with springs, the wire mat upon being loaded by a person on the vehicle seat in a horizontal direction can be pressed to the back.

It is necessary that at a distance from the wire mesh to the backrest is provided with a back lining, e.g., a fabric. Here, a gap exists between the wire mat and the back lining in the range of for example, approximately 3 cm to approximately 4 cm for the required spring travel. Therefore, the backrest altogether has a large thickness because with respect to the thickness it is substantially composed of the thickness of the upholstery, of the wire mat as well as the gap between the wire mat and the back lining. Disadvantageously, the vehicle seat in a vehicle interior, particularly in the case of a front seat, requires a large installation space so that because of this little legroom is available for back passengers on the back seats.

From FR 2 779 393 a vehicle seat with a seat part and a backrest is known. There, the backrest comprises upholstery and the upholstery rests on a plate. The plate is moveably fastened to a frame with springs.

At least one object is to make available a vehicle seat and a motor vehicle wherein the backrest requires little space. In addition, other objects, desirable features, and characteristics will become apparent from the subsequent summary and detailed description, and the appended claims, taken in conjunction with the accompanying drawings and this background.

### SUMMARY

A vehicle seat, particularly for a motor vehicle, is provided with a backrest that comprises an elastic upholstery and a support for the upholstery. The support is designed as a plate, particularly plastic plate. In particular, the backrest comprises a frame for the fastening of at least one component of the backrest and/or the vehicle seat comprises, particularly on the backrest, a head restraint and/or the plate supports the upholstery at the back indirectly or directly.

In another embodiment, the upholstery only partially rests on the plate in a horizontal and/or vertical section. The vehicle seat is thus in particular not a sports seat, with which an upholstery, e.g., of foam rubber substantially rests completely on a plastic shell. In a complementary embodiment the upholstery, in a horizontal section on two lateral end portions, does not rest on the plate and/or the upholstery, in a vertical section, on an upper end portion and on a lower end portion does not rest on the plate and preferentially the lateral end portions comprise at least approximately 5%, approximately 10%, approximately 20% or approximately 30% of the horizontal extension of the upholstery in the horizontal section and preferentially the upper and lower end portion comprises at least approximately 5%, approximately 10%, approximately 20% or approximately 30% of the vertical extension of the upholstery in the vertical section.

Preferentially, the upholstery rests on the plate only on a central portion of the upholstery. In a version, the backrest comprises a frame and the plate is indirectly or directly fastened to the frame substantially rigidly, e.g., without at least one spring. Substantially rigid in this case means that during a normal loading of the vehicle seat with a person on the vehicle seat the plate describes a vertical and/or a horizontal movement of deformation of less than approximately 2 cm, approximately 3 cm, or approximately 0.5 cm. Practically, the elastic properties of a support surface of the backrest are substantially formed by the upholstery. Substantially, the plate has no elastic deformations during a normal loading of the vehicle seat with a person on the vehicle seat, so that because of this the elastic properties on the support surface are substantially formed or made available by the elastic upholstery, in particular of foam rubber.

In a further embodiment, the backrest comprises no back lining, e.g., a fabric or a lining plate, so that the plate is accessible from the back, particularly directly. Since the plate substantially performs no deformations, no additional back lining on the plate is required, so that because of this the thickness of the vehicle seat is very small and the vehicle seat therefore requires only very little installation space within an interior of a motor vehicle. Substantially completely accessible directly means that more than approximately 70%, approximately 80%, or approximately 90% of the back of the plate is directly accessible from the back. In particular, the backrest comprises an electric or pneumatic lumbar vertebrae support.

In a complementary version, the backrest is pivot-mounted. Here, the backrest is pivotably mounted in a pivotable manner about a substantially horizontal transverse axis on the seat part or on another component of the motor vehicle, e.g., a body. Because of this, the backrest with a front seat can be pivoted between different positions. In an additional configuration the vehicle seat, particularly the seat part and/or the backrest and/or the head restraint comprise a cover, e.g., of fabric or leather. The cover rests on the upholstery, particularly at the backrest, and the cover serves as support surface for a person on the vehicle seat.

A motor vehicle, particularly passenger car, is provided with at least one vehicle seat. The vehicle seat, particularly rear seat, is embodied as a vehicle seat described in this patent application.

### BRIEF DESCRIPTION OF THE DRAWINGS

The present invention will hereinafter be described in conjunction with the following drawing figures, wherein like numerals denote like elements, and:

FIG. 1 is a perspective view of a vehicle seat;

FIG. 2 is a vertical section A-A according to FIG. 1 of a backrest of the vehicle seat from the prior art;

FIG. 3 is a vertical section A-A according to FIG. 1 of the backrest in a first exemplary embodiment of the vehicle seat according to an embodiment;

FIG. 4 is a vertical section A-A according to FIG. 1 of the backrest in a second exemplary embodiment of the vehicle seat;

FIG. 5 is a vertical section A-A according to FIG. 1 of the backrest in a third exemplary embodiment of the vehicle seat;

FIG. 6 is a vertical section A-A according to FIG. 1 of the backrest in a fourth exemplary embodiment of the vehicle seat;

FIG. 7 is a vertical section A-A according to FIG. 1 of the backrest in a fifth exemplary embodiment of the vehicle seat;

FIG. 8 is a vertical section A-A according to FIG. 1 of the backrest in a sixth exemplary embodiment of the vehicle seat;

FIG. 9 is exploded representation of a plate with a frame and an electrical and pneumatic lumbar vertebrae support;

FIG. 10 is a vertical section A-A according to FIG. 1 of the backrest in a seventh exemplary embodiment of the vehicle seat; and

FIG. 11 is a lateral view of a motor vehicle.

### DETAILED DESCRIPTION

The following detailed description is merely exemplary in nature and is not intended to limit application and uses. Furthermore, there is no intention to be bound by any theory presented in the preceding background or the following detailed description.

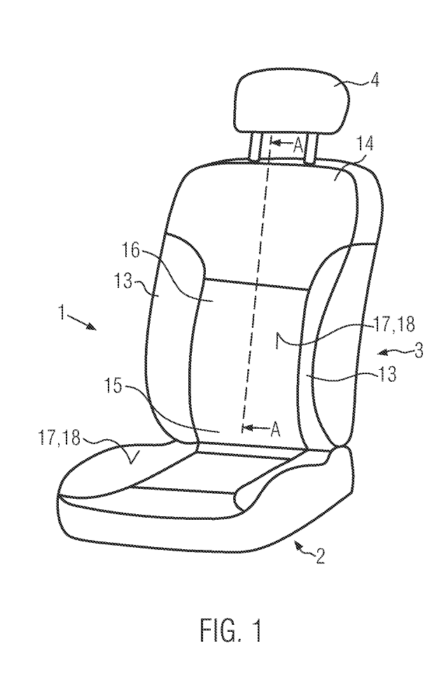

FIG. 1 shows a perspective view of a motor vehicle 1. The vehicle seat 1 is employed in a vehicle 28, particularly passenger car 29, so that persons can take a seat on the vehicle seat 1 in the vehicle interior. Preferentially, the vehicle seat 1 in this case is a front seat. The motor vehicle 28 in this case comprises both front seats as well as back seats (not shown).

The vehicle seat comprises a seat part 2 and a backrest 3. A head restraint 4 is fastened to the backrest 3. Here, the backrest 3 is pivotably mounted with respect to the seat part 2 about a horizontal transverse axis that is not shown. The backrest 3 comprises a central portion 16, two lateral end portions 13 and an upper end portion 14 and a lower end portion 15 (FIG. 1).

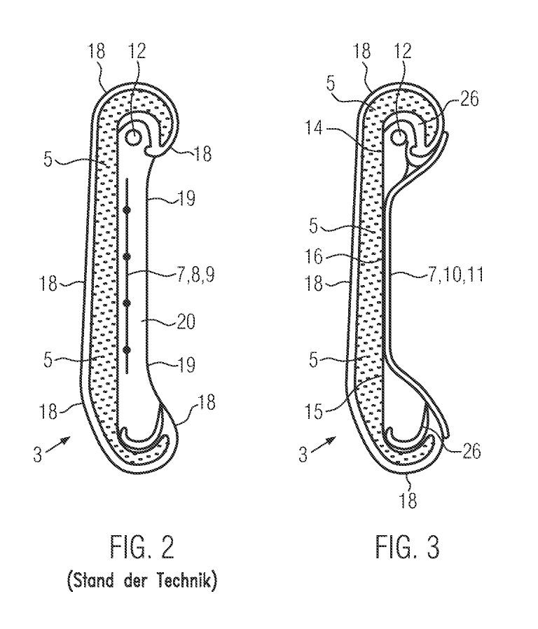

FIG. 2 shows a backrest 3 known from the prior art in a section A-A according to FIG. 1. The backrest 3 comprises an elastic upholstery 5, on which a covering 18 of fabric rests. The upholstery 5 rests on a support 7 as wire mat 8 or wire mesh 9. The wire mat 8 or the wire mesh 9 in this case is fastened to a U-shaped frame 12. The wire mat 8 or the wire mesh 9 is elastic and/or elastically fastened to the frame 12, e.g., with springs (not shown). If on the backrest 3 because of a person located on the vehicle seat 1 a substantially horizontal force to the back is exerted, not only is the elastic upholstery 5 deformed but the wire mat 8 moves to the back as well. For this reason, a back lining 19 is present between the wire mat 8 or the wire mesh 9 in an undeformed state at a spacing of approximately 3 cm to approximately 4 cm. Because of this, a gap 20 in a thickness of approximately 3 cm to approximately 4 cm is formed between the wire mat 8 and the back lining 19 in an undeformed state of the wire mat 8 in order to be able to absorb corresponding deformations of the wire mesh 9. In disadvantageous manner the backrest 3 known from the prior art thus requires a larger installation space in horizontal direction, so that upon a use of the vehicle seat 1 as front seat the back passengers on the back seats only have little leg room.

FIG. 3 shows a section A-A according to FIG. 1 of the backrest 3 of a vehicle seat 1. Here, the backrest 3, like the vehicle seat 1 known from the prior art, comprises an elastic upholstery 5, e.g., as foam rubber, as well as a covering 18 of fabric, which rests on the upholstery 5. For supporting or absorbing forces, the backrest 3 comprises as support 7 a substantially rigid plate 10 instead of a wire mat 8 or a wire mesh 9, particularly a plastic plate 11. Here, the vehicle seat 1 on the backrest 3 does not have a back lining 19 either, e.g. as fabric, because the plate 10 is substantially fastened rigidly to the frame 12 indirectly or directly. If a person is seated on the vehicle seat 1, an elastic deformation on the backrest 3 on a support surface 17, which the covering 18 constitutes, is substantially performed only because of the elastic deformation of the upholstery 5 and not because of an elastic deformation of the support 7 from the plate 10. In an advantageous manner, the vehicle seat 1 is thus not provided with the back lining 19 on the backrest 3 because the plate 10 is substantially not deformable, in particular elastically. Because of this the backrest 3 in an advantageous manner only has a small thickness and the vehicle seat 1 because of this requires only very little installation space so that because of this back passengers when using the vehicle seat 1 as front seat have greater leg room available than when using a vehicle seat 1 known from the prior art.

The plate 10 rests only on the central portion 16 of the upholstery 5. At the upper and lower end of the backrest 3, it is provided with a metal part 26 each. The metal part 26 in this case is fastened indirectly or directly to the frame 12 and the metal part 26 serves for fastening or clamping-in the upholstery 5. In the first exemplary embodiment of the backrest 3 shown in FIG. 3 the plate 10 is provided with a fork-like widening at the upper end, in which the upper end of the upholstery 5 and the metal part 26 are arranged. Here, the vertical extension of the plate 10 is smaller than the entire height of the backrest 3, so that the plate 10 in its vertical extension only takes up a part of the vertical extension of the backrest 3. The preferentially U-shaped frame 12 consists of metal, e.g., steel or aluminum, and/or of plastic. Here, preferentially any fastening device for the indirect and direct fixing of the backrest 3 to another component, e.g., body or chassis, is to be understood as frame 12.

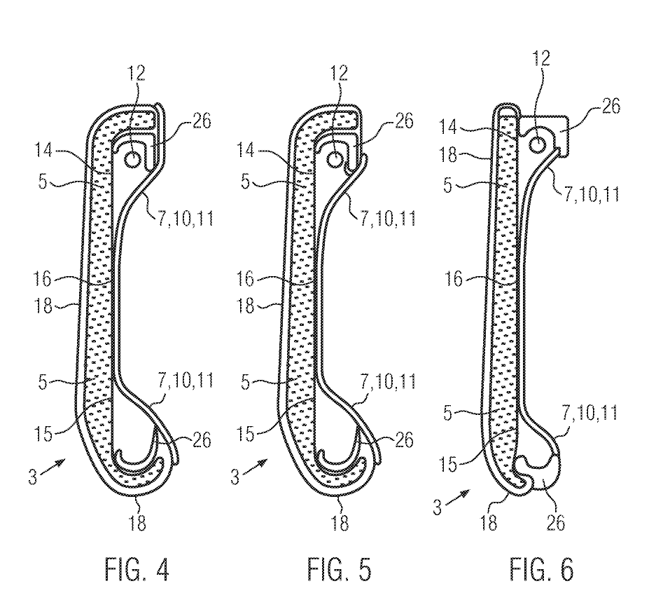

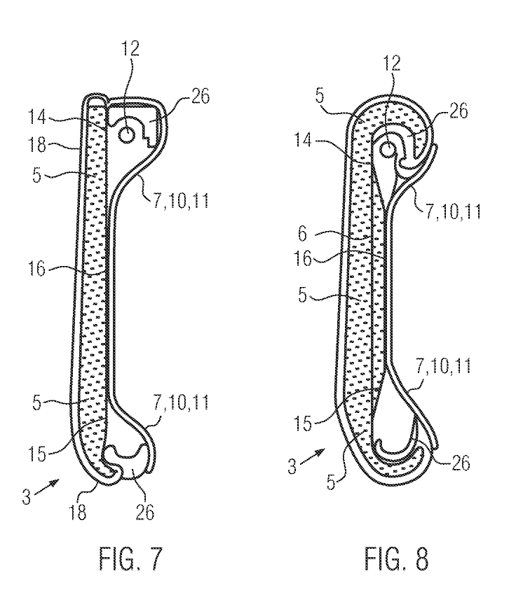

FIG. 4 shows a second exemplary embodiment of the backrest 3. In the following exemplary embodiments according to FIG. 4 to FIG. 8, only the differences to the first vehicle seat 1 with the backrest 3 according to FIG. 3 are described. In the second exemplary embodiment according to FIG. 4 the upper end of the plate 10 is run up to the upper end of the upholstery 5 and comprises no forking and the lower end of the plate 10 is run to below the lower end of the lower metal part 26. In the third exemplary embodiment according to FIG. 6 the plate 10 comprises a forking at the upper end in which the upholstery 5 is not arranged, and in the third exemplary embodiment according to FIG. 5 the plate 10 rests both on the upper as well as the lower end on the metal part 26 and is fastened to the frame 12 indirectly or directly analogously to the preceding exemplary embodiments. Here, in the third exemplary embodiment shown in FIG. 5, the plate 10 rests on a back end of the metal part 26. In contrast with this, in the fourth exemplary embodiment shown in FIG. 6, the plate 10 rests on an upper and lower end of the metal part 26. In the fifth exemplary embodiment shown in FIG. 7, the upper end of the plate 10 is substantially run completely and the upper metal part 26 on the outside and the lower end of the plate 10 is arranged or fastened on the rear end of the metal part 26. In the sixth exemplary embodiment shown in FIG. 8, the upholstery 5 in addition to the upholstery 5 comprises an additional upholstery 6. The additional upholstery 6 in this case can either be designed unitarily with the upholster 5 (not shown) or be designed as additional component separately from the upholstery 5 (FIG. 8). In the sixth exemplary embodiment shown in FIG. 8, the upholstery 5 together with the additional upholstery 6 thus has a greater thickness so that the backrest 3 on the support surface 17 has a greater elastic deformability and thereby both the upholstery 5 and the additional upholstery 6 are preferentially designed softer.

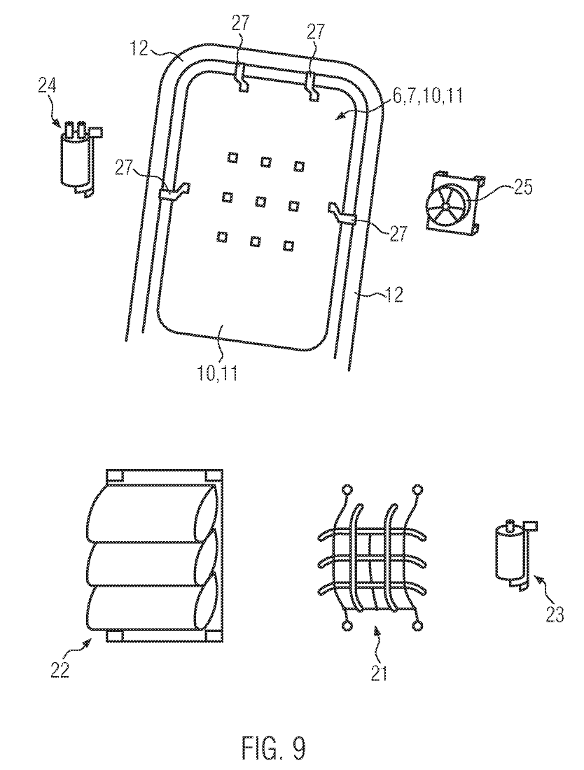

FIG. 9 shows an exploded representation and a perspective view of the plastic plate 11. The plate 10 or plastic plate 11 is fastened to the U-shaped frame 12 by means of fastening straps 27. Here, the vehicle seat 1 comprises either a pneumatic lumbar vertebrae support 22 or an electric lumbar vertebrae support 21. The pneumatic lumbar vertebrae support 22 is operated by a pneumatic pump 22, so that because of this the size of the pneumatic lumbar vertebrae support 22 can be changed. Analogously, the size of the pneumatic lumbar vertebrae support 22 can also be changed with the electric lumbar vertebrae support 21 by an electric motor 23. In the case of the pneumatic lumbar vertebrae support 22 with pneumatic pump 24, both the pneumatic lumbar vertebrae support 22 as well as the pneumatic pump 24 are fastened to the plastic plate 11 and in analogous manner upon a design of the vehicle seat 1 with the electric lumbar vertebrae support 21, both the electric lumbar vertebrae support 21 as well as the electric motor 23 are fastened to the plastic plate 11.

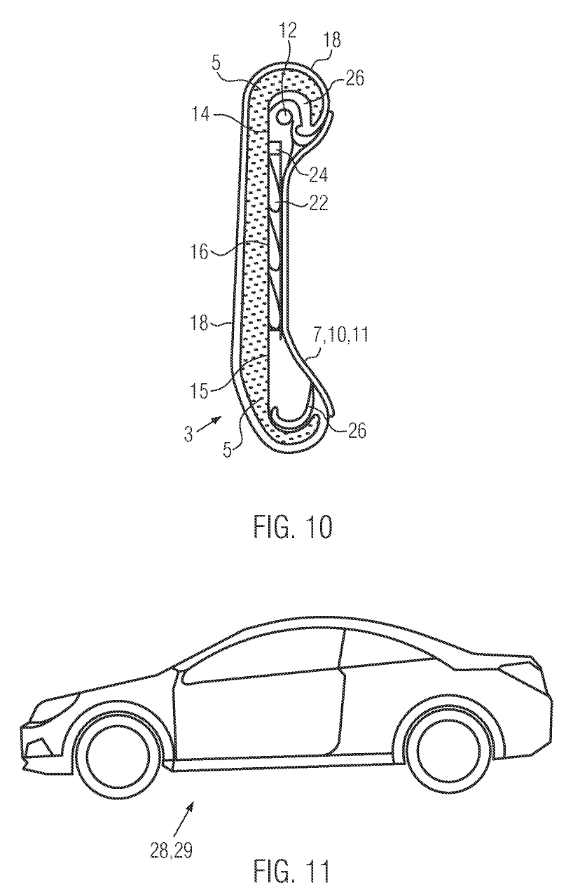

In addition, the vehicle seat 1 also comprises a blower 25 for ventilating the backrest 3. During the manufacture of the vehicle seat 1, these components 21, 22 or 23, 24 and/or 25 can thus be simply fastened initially to the plastic plate 11 and the plastic plate 11 with these components 21, 22 or 23, 24 and/or 25 can then be simply fastened to the vehicle seat 1. FIG. 10 shows a section A-A according to FIG. 1 of the backrest 3 with the pneumatic lumbar vertebrae support 22. The pneumatic lumbar vertebrae support 22 in this case is arranged in the lower third of the backrest 3 between the upholstery 5 and the plastic plate 11. Above the pneumatic lumbar vertebrae support 22, the pneumatic pump 24 for blowing up the pneumatic lumbar vertebrae support 22 is arranged.

Seen overall, the vehicle seat 1 and the motor vehicle 28 combine substantial advantages. Because of the substantially non-deformable plastic plate 11 as support 7 for the upholstery 5, the backrest 3 has a smaller thickness, so that because of this the backrest 3 requires less installation space within a vehicle interior.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A backrest for a vehicle seat, comprising:
an elastic upholstery; and
a plate configured as a support for the elastic upholstery.

2. The backrest according to claim 1, wherein the plate is a plastic plate.

3. The backrest according to claim 1, further comprising a frame configured to fasten a component of the backrest,
wherein the plate is configured to directly support the elastic upholstery at the back.

4. The backrest according to claim 1, further comprising a frame configured to fasten a component of the backrest,
wherein the plate is configured to indirectly support the elastic upholstery at the back.

5. The backrest according to claim 1, wherein the elastic upholstery in a horizontal section only partially rests on the plate.

6. The backrest according to claim 1, wherein the elastic upholstery in a vertical section only partially rests on the plate.

7. The backrest according to claim 1,
wherein the elastic upholstery in a horizontal section does not rest on the plate on two lateral end portions,
wherein the elastic upholstery in a vertical section does not rest on the plate on an upper end portion and on a lower end portion and in that the two lateral end portions comprise at least approximately 5% of a horizontal extension of the elastic upholstery in the horizontal section and in the upper end portion and the lower end portion comprises at least approximately 5% of a vertical extension of the elastic upholstery in the vertical section.

8. The backrest according to claim 1,
wherein the elastic upholstery in a horizontal section does not rest on the plate on two lateral end portions,
wherein the elastic upholstery in a vertical section does not rest on the plate on an upper end portion and on a lower end portion and in that the two lateral end portions comprise at least approximately 10% of a horizontal extension of the elastic upholstery in the horizontal section and in the upper end portion and the lower end portion comprises at least approximately 10% of a vertical extension of the elastic upholstery in the vertical section.

9. The backrest according to claim 1,
wherein the elastic upholstery in a horizontal section does not rest on the plate on two lateral end portions,
wherein the elastic upholstery in a vertical section does not rest on the plate on an upper end portion and on a lower end portion and in that the two lateral end portions comprise at least approximately 20% of a horizontal extension of the elastic upholstery in the horizontal section and in the upper end portion and the lower end portion comprises at least approximately 20% of a vertical extension of the elastic upholstery in the vertical section.

10. The backrest according to claim 1,
wherein the elastic upholstery in a horizontal section does not rest on the plate on two lateral end portions,
wherein the elastic upholstery in a vertical section does not rest on the plate on an upper end portion and on a lower end portion and in that the two lateral end portions comprise at least approximately 30% of a horizontal extension of the elastic upholstery in the horizontal section and in the upper end portion and the lower end portion comprises at least approximately 30% of a vertical extension of the elastic upholstery in the vertical section.

11. The backrest according to claim 1, wherein the elastic upholstery is configured to only rest on the plate on a central portion of the elastic upholstery.

12. The backrest according to claim 1, further comprising a frame and the plate is substantially fastened directly to the frame.

13. The backrest according to claim 1, further comprising a frame and the plate is substantially fastened indirectly to the frame.

14. The backrest according to claim 1, wherein elastic properties of a support surface of the backrest are substantially formed by the elastic upholstery.

15. The backrest according to claim 1, wherein the backrest is substantially void of a back lining so that the plate from the back is directly accessible.

16. The backrest according to claim 1, wherein the backrest comprises a lumbar vertebrae support.

17. The backrest according to claim 16, wherein the lumbar vertebrae support is pneumatic.

18. The backrest according claim 17, wherein the lumbar vertebrae support is fastened to the plate.

19. The backrest according to claim 1, wherein the backrest is configured to pivot.
